(19) United States
(12) Patent Application Publication
(10) Pub. No.: US 2004/0037071 A1
(43) Pub. Date: Feb. 26, 2004

(54) Innovated flashing decorative article

(76) Inventor: Ching-Hui Lee, Taichung (TW)

Correspondence Address: Liberty Patent and Trademark Office, P.O. Box 590, Taichung City, 400, TW

(21) Appl. No.: 10/443,907

(22) Filed: May 23, 2003

(30) Foreign Application Priority Data
Aug. 21, 2002 (CN) 02 2 49240.2

(51) Int. Cl. F21L 4/00

(52) U.S. Cl. 362/190; 362/191; 362/192; 362/194; 362/398; 362/806

(57) ABSTRACT

An innovated flashing decorative article, comprising of an upper hollow pipe, a lower hollow pipe and an exterior magnet. On the top rim of the upper hollow pipe are two symmetrically positioned insert pins and a circuit board that is connected via the insert pins to the upper hollow pipe. On the circuit board are an IC and LED. The upper side of the circuit board is coated with transparent glue. Inside the upper hollow pipe is an insulating paper. At a lower part of the upper hollow pipe is an exterior pipe thread. Inside the lower hollow pipe is an interior pipe thread. On the bottom of the lower hollow pipe is a magnet. Inside the hollow of the lower hollow pipe are one to three batteries. The exterior pipe thread and interior pipe thread of the upper and lower hollow pipes are screwed together. The exterior magnet is independently installed outside the upper and lower hollow pipes. Due to variability of the shape of the circuit board, the present invention of flashing decorative article provides more fun. By screwing the upper and lower hollow pipes together, the circuit board is activated to turn on the LED lamp, which serves as a switch. The product is compact to carry and easy to use.

### BACKGROUND OF THE INVENTION

(a) Field of the invention

The present invention relates to an innovated flashing decorative article.

(b) Description of the Prior Art

Most conventional decorative articles are without flashing light and lack of amusement effect. Though a few decorative articles may have light flashing function, they will not function until they are switched on. Therefore, the additional switch mechanism complicates the construction of the product.

### BRIEF DESCRIPTION OF THE INVENTION

The present invention comprises an upper hollow pipe, a lower hollow pipe and an exterior magnet. On the rim of the top of the upper hollow pipe are two symmetrically positioned insert pins and a circuit board that is connected via the insert pins to the upper hollow pipe. On the circuit board is an Integrated Circuit chip (IC) and a Light Emitting Diode, LED. The upper side of the circuit board is coated with a layer of transparent glue. Inside the upper hollow pipe is a ring of insulating paper. At a lower part of the upper hollow pipe is an exterior pipe thread. Inside the lower hollow pipe is an interior pipe thread. On the bottom of the lower hollow pipe is a magnet. Inside the hollow of the upper and lower hollow pipes are one to three batteries. The exterior pipe thread and the interior pipe thread of the upper and lower hollow pipes are screwed together. The exterior magnet on the outside of the upper and lower hollow pipes is optionally replaced by a metal ring installed on the bottom of the lower hollow pipe, forming a ring shape.

Due to the variability of the shape of the circuit board and the LED installed on the circuit board, the present invention of light flashing decorative article has the effect of fin and amusement. Besides, tightening of the upper hollow pipe with the lower hollow pipe activates the circuit board, which in turn turns on the LED. This function serves as a switch, enabling compact construction and convenient use of the present invention.

### BRIEF DESCRIPTION OF DRAWINGS

FIG. 1 is a side view of the invention.

FIG. 2 is a section view taken from A-A of FIG. 1 without the exterior magnet.

FIG. 3 is a side view of the upper hollow pipe in the invention.

FIG. 4 is a side view of the lower hollow pipe in the invention.

FIG. 5 is a top view of the circuit board in the invention.

FIG. 6 is a schematic view of an embodiment of the invention.

FIG. 7 is an embodiment view of the circuit board in the invention.

FIG. 8 is another embodiment view of the circuit board in the invention.

### DETAILED DESCRIPTION OF PREFERRED EMBODIMENTS

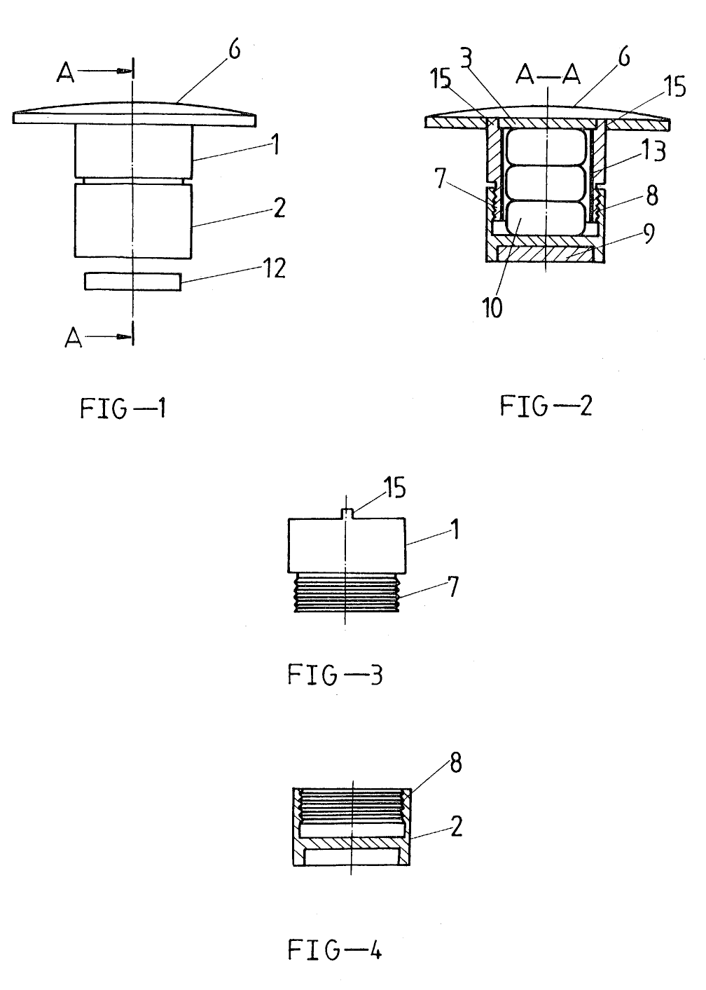

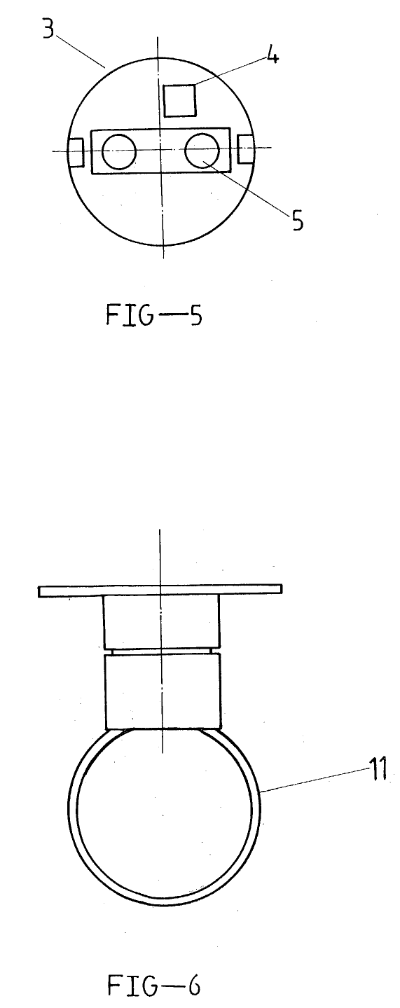

As shown in FIGS. 1 through 5, the present invention comprises an upper hollow pipe 1, a lower hollow pipe 2 and an exterior magnet 12. On the rim of the top of the upper hollow pipe 1 are two symmetrically positioned insert pins 15 and a circuit board 3 that is connected via the two insert pins 15 to the upper hollow pipe 1. On the circuit board 3 are an IC 4 and an LED 5. The upper side of the circuit board 3 is coated with transparent glue 6. Inside the upper hollow pipe 1 is a ring of insulating paper 13. At the lower part of the upper hollow pipe 1 is an exterior pipe thread 7. Inside the lower hollow pipe 2 is an interior pipe thread 8. At the bottom of the lower hollow pipe 2 is a magnet 9. Inside the hollow of the upper and lower hollow pipes 1 and 2 are three batteries 10. The upper and lower hollow pipes 1,2 are joined by screwing the exterior pipe thread 7 with the interior pipe thread 8. The exterior magnet 12 is independently installed on the outside of the upper and lower hollow pipes.

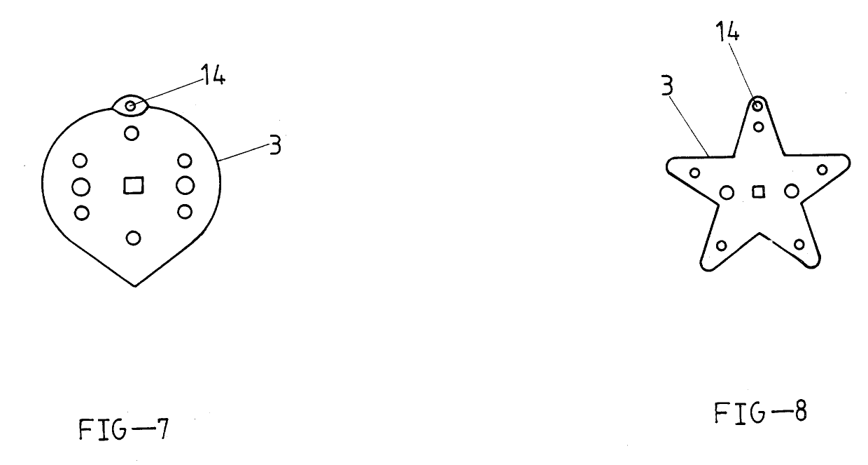

As shown in FIGS. 5, 7 and 8, the circuit board 3 is optionally shaped like a circle, a heart and a star. On the top of the circuit board 3 is a round hole 14. Optionally, there is a transparent plastic unit or glass unit on the outside of the circuit board 3 to join firmly with the upper hollow pipe 1. Optionally, the exterior magnet 12 outside the upper and lower hollow pipes 1, 2 is replaced by a metal ring 11 installed on the bottom of the lower hollow pipe 2 (as shown in FIG. 6), forming a ring shape.

What is claimed is:

1. A innovated flashing decorative article, comprising an upper hollow pipe, a lower hollow pipe and an exterior magnet, on a rim of a top of said upper hollow pipe being two symmetrically positioned insert pins, and a circuit board that is connected via the insert pins to the upper hollow pipe, on said circuit board being IC and LED, the upper side of the circuit board being coated with a layer of transparent glue, inside the upper hollow pipe being a ring of insulating paper, at a lower part of the upper hollow pipe being an exterior pipe thread, inside the lower hollow pipe being an interior pipe thread, at a bottom of the lower hollow pipe being a magnet, inside the hollow upper and lower pipes being one to three batteries, the exterior pipe thread and interior pipe thread of the upper and lower hollow pipes being screwed together, the exterior magnet being independently installed outside of the upper and lower hollow pipes.

2. The innovated flashing decorative article of claim 1, characterized in that, the circuit board is optionally shaped like a circle, a heart or a star, there being a round hole on a top of the circuit board, and optionally there is a transparent plastic unit or a glass unit outside the circuit board for tight fastening purpose to the upper hollow pipe.

3. The innovated flashing decorative article of claim 1, characterized in that, the exterior magnet outside the upper and lower hollow pipes could be optionally replaced by a metal ring attached to a bottom of the lower hollow pipe, thereby forming a ring shape.
